(19) United States
(12) Patent Application Publication
(10) Pub. No.: US 2009/0241534 A1
(43) Pub. Date: Oct. 1, 2009

(54) ENERGY ACCUMULATOR UNIT

(75) Inventors: Seppo Tikkanen, Ulm (DE); Sebastian Oschmann, Strass (DE)

Correspondence Address: SCULLY SCOTT MURPHY & PRESSER, PC, 400 GARDEN CITY PLAZA, SUITE 300, GARDEN CITY, NY, 11530, US

(73) Assignee: ROBERT BOSCH GMBH, Stuttgart (DE)

(21) Appl. No.: 12/443,010

(22) PCT Filed: Sep. 26, 2007
(86) PCT No.: PCT/EP07/08392

§ 371 Date: Mar. 26, 2009

(30) Foreign Application Priority Data
Sep. 28, 2006 (DE) 10 2006 046 127.4

(51) Int. Cl. F15B 1/02

(52) U.S. Cl. 60/413

(57) ABSTRACT

The invention relates to an energy storage unit for a hydrostatic-mechanical drive system (1). The energy storage unit (31) comprises at least one hydrostatic machine (33) which can be connected to the drive system (1) via a mechanical interface (35). Furthermore, the energy storage unit (31) comprises a storage element (32) which is connected to a hydrostatic machine (33) via a storage line (36). The storage line (36) can be connected to a hydraulic interface (38), and the hydraulic interface (38) is provided for the purpose of connecting the energy storage unit (1) to the drive system (1).

The invention relates to an energy accumulator unit for a hydrostatic-mechanical drive system.

A hydrostatic drive device for a motor vehicle and a method for operating this drive device are known from AT 395 960 B. The hydrostatic drive device comprises a drive motor, which has a hydrostatic pump designed as a fixed displacement pump. The hydrostatic pump is connected via a first working line and a second working line to a hydraulic motor for driving the vehicle. Connected to the two working lines is in each case one accumulator element, so that, in overrun condition of the vehicle, the hydraulic motor owing to its pumping action can fill an accumulator element and thus accumulate kinetic energy in the form of pressure energy.

To recover the accumulated energy, the pressure medium accumulated in the accumulator element is fed back to the circuit and drives the hydraulic motor.

The disadvantage of the described system is that, for the accumulation and recovery of energy, only accumulator elements are connected to the hydrostatic circuit which is provided for driving the vehicle. Consequently, the energy accumulating function is possible to taking up kinetic energy and feeding back pressure energy via the hydrostatic circuit. In particular, the energy flow is possible only between the hydrostatic drive and the accumulator element.

The object of the invention is to provide an energy accumulator unit which enables a flexible energy flow, so that the accumulated energy can be utilised also by alternative subregions of a drive system.

The object is achieved by the energy accumulator unit according to the invention having the features of claim 1.

The energy accumulator unit according to the invention for a hydrostatic-mechanical drive system comprises at least one hydrostatic machine, for example a hydrostatic piston machine, at least one accumulator element, which is connected to the hydrostatic machine via an accumulator line, and a hydraulic interface, which can be connected to the accumulator line. The hydrostatic machine of the energy accumulator unit can be connected to the drive system via a mechanical interface. Furthermore, the hydraulic interface can be connected to the drive system. Consequently, the energy accumulator unit can be connected both to a mechanical part of the drive system and to the hydrostatic part of the drive system.

Energy in the form of pressure energy can be accumulated in the energy accumulator unit by the accumulator element. This pressure energy is thus available to the hydrostatic machine, via which a torque can be produced which can be delivered to the hydrostatic-mechanical drive system via the mechanical interface. On the other hand, the pressure energy accumulated in the accumulator element can also be delivered to a hydraulic part of the hydrostatic-mechanical drive system via the hydraulic interface. In a corresponding manner, all or some of the energy flows can also be reversed. This means that it is possible to supply energy on the one hand via the hydraulic interface and on the other hand via the mechanical interface.

The flexibility of the energy accumulator is based on the fact that the energy accumulator unit has at least two interfaces which are both equally suitable for energy flows to the energy accumulator unit or from it. Consequently, not only is it possible to accumulate and recover energy, but it is also possible to convert one form of energy to another. Through the more flexible utilisation of the released energies, it is possible to save primary energy which is used.

Advantageous developments of the accumulator unit according to the invention are set out in the subclaims.

In particular, it is advantageous if the energy accumulator unit comprises a control unit for controlling the energy flow via the mechanical and/or the hydraulic interface. The control unit can be connected to the drive system via a control interface. Through the connection of the control unit via the control interface, it is possible to ascertain by a control device of the drive system the regions of the drive system in which energy is currently being released and, in contrast, the regions in which energy has to be used. The control unit can thus receive a control signal via the interface, whereupon the energy accumulator unit is controlled by its integrated control unit in accordance with the required energy flow.

In this case, it is particularly advantageous if the hydraulic interface can be connected to the accumulator line via an interface line, a controllable valve being arranged in the interface line. This controllable valve allows, for example, the energy flow via the hydraulic interface to be interrupted or enabled.

In this case, the controllable valve is controlled by the control unit. In dependence on a signal received via the control interface, it is therefore ascertained by the control unit whether an energy flow via the hydraulic interface is required. If no energy flow in any direction is required there, then the controllable valve is controlled in such a way that the connection in the interface line is interrupted.

Furthermore, it is advantageous to arrange pressure sensors on both sides of the controllable valve. These pressure sensors supply signals relating to the pressure in the hydraulic part of the drive system and to the pressure in the accumulator element. In dependence on the pressures measured there, it is possible to ascertain by the control unit itself whether a contribution of the energy accumulator unit can be made to be required energy flow.

If, for example, the required energy flow were to lead, via the hydraulic or the mechanical interface, into the energy accumulator unit and if, however, the accumulator element has already been fully charged, then a further supply of energy to the energy accumulator unit cannot take place. The controllable valve therefore remains in its closed position or the piston machine is set to zero delivery volume, unless an energy flow can take place from the energy accumulator unit via the interface.

The hydrostatic machine is preferably provided for delivery in both directions and is designed to be adjustable in its delivery volume. The hydrostatic machine can be operated on the one hand as a pump and on the other hand as a motor, with the result that an energy flow is possible in both directions via the mechanical interface.

The hydrostatic machine is controlled in its delivery direction and in its delivery volume preferably likewise by the control unit. Consequently, the energy flow via the mechanical interface can also be controlled by the control unit. A further preferred embodiment is obtained if a shut-off valve is arranged between a connecting point of the accumulator line, to the interface line, and the accumulator element. With the aid of such a shut-off valve, it is possible, for example, for an energy flow to take place between the mechanical interface and the hydraulic interface while bypassing the accumulator element, if the accumulator is completely full.

A preferred exemplary embodiment of the energy accumulator unit according to the invention is illustrated in the drawing and is explained in more detail in the following description, in which:

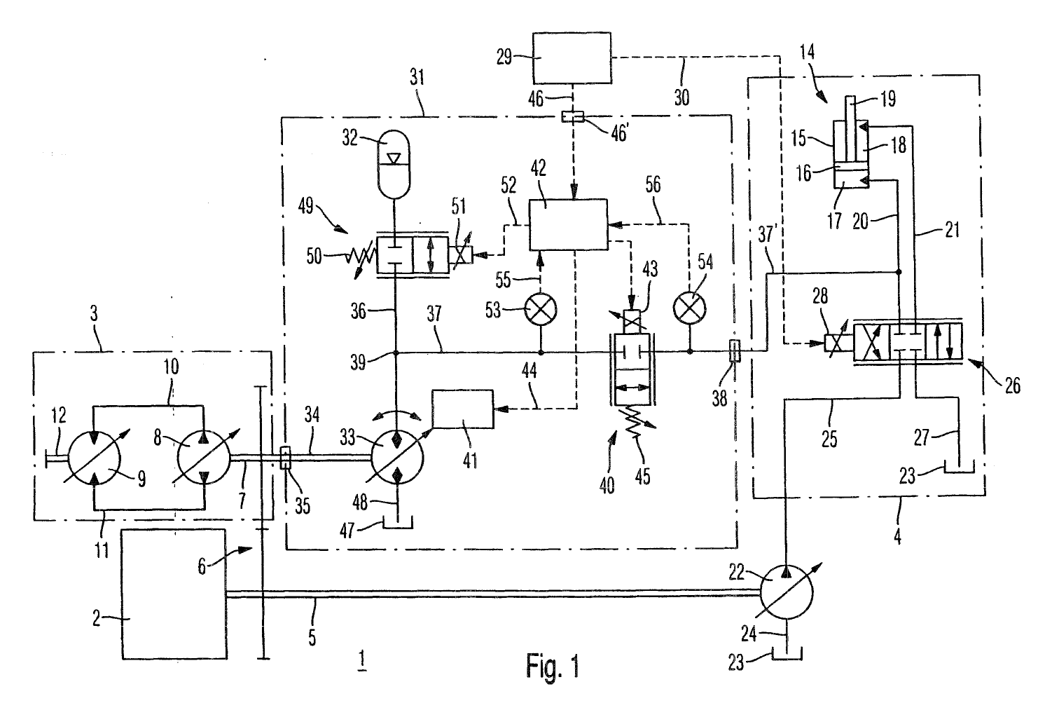

FIG. 1 shows a block diagram of a hydrostatic-mechanical drive system having an energy accumulator unit according to the invention.

FIG. 1 illustrates a drive system 1 which comprises, as the primary driving engine, for example a diesel internal combustion engine 2. The diesel internal combustion engine 2 is coupled to a mechanical part of the drive system 1, which comprises a hydrostatic gearing 3 in the exemplary embodiment illustrated. Furthermore, the diesel internal combustion engine 2 is connected to a hydrostatic part of the drive system, the components of which are illustrated in FIG. 1 as a whole with the reference symbol 4. To drive the hydrostatic gearing 3 and the hydrostatic part 4 of the drive system 1, the diesel internal combustion engine 2 drives a drive shaft 5. The drive shaft 5 cooperates directly with the hydrostatic part 4 of the drive system 1 and drives a hydraulic pump 22 there. The drive shaft 5 is connected to a gearing input shaft 7 of the hydrostatic gearing 3 via a gearing stage 6.

The hydrostatic gearing 3 comprises a hydraulic pump 8 and a hydraulic motor 9, which are connected to one another in a closed circuit via a first working line 10 and a second working line 11. To set the transmission ratio of the hydrostatic gearing 3, the hydraulic pump 8 and the hydraulic motor 9 are each designed to be adjustable in their delivery volume. The drive torque produced by the hydraulic motor 9 is supplied via a motor shaft 12, for example, to a downstream change-speed gearing. The hydrostatic gearing 3 is chosen merely for purposes of illustration. Any other form of a mechanical part of the drive system 1 instead of the hydrostatic gearing 3 is also conceivable.

The hydrostatic part 4 of the drive system 1 comprises, in the illustrated exemplary embodiment, working hydraulics 14 which are provided, for example, for lifting or lowering the boom of a digger. The working hydraulics 14 comprise a double-acting hydraulic cylinder 15, in which a setting piston 16 is arranged. The setting piston 16 divides the hydraulic cylinder 15 into a first setting pressure chamber 17 and a second setting pressure chamber 18. Upon a movement of the setting piston 16, a piston rod 19 is displaced in the axial direction, so that a component connected thereto is moved relative to the hydraulic cylinder 15. In order to produce a setting movement of the setting piston 16, a setting pressure acts in the setting pressure chambers 17, 18 in each case. Owing to the hydraulic forces which the setting pressures produce in the setting pressure chambers 17, 18, a resultant force acts on the setting piston 16 and leads to a movement of the setting piston 16. In order to be able to set a corresponding setting pressure in the setting pressure chamber 17 and the setting pressure chamber 18, respectively, the setting pressure chambers 17, 18 are connected to a regulating valve 26 via a first setting pressure line 20 and a second setting pressure line 21, respectively.

To produce the required pressure in order to be able to produce a setting pressure in one of the setting pressure chambers 17, 18, a pump 22 is provided. The pump 22 is designed, in the exemplary embodiment illustrated, to be adjustable in its delivery volume and is provided for delivery in one direction only. The pump 22 is likewise connected to the drive shaft 5 and is thus driven at the rotational speed of the diesel internal combustion engine 2. The pump 22 draws in pressure medium from a tank volume 23 via a suction line 24 and delivers it to a delivery line 25 in accordance with the set delivery volume of the pump 22. The delivery line 25 is connected to the regulating valve 26. The regulating valve 26 is a 4/3-port directional control valve in the exemplary embodiment illustrated. Connected to the fourth port of the regulating valve 26 is a relief line 27, of which the end remote from the regulating valve 26 opens into a tank volume 23.

In the illustrated neutral position of the regulating valve 26, the first and second setting pressure lines 20, 21 and the delivery line 25 as well as the relief line 27 are in each case separated from one another. In a first end position of the regulating valve 26, in contrast, the delivery line 25 is connected to the second setting pressure line 21 and at the same time the first setting pressure line 20 is connected to the relief line 27. In the opposite end position of the regulating valve 26, in contrast, the first setting pressure line 20 is connected to the delivery pressure line 25 and the second setting pressure line 21 is connected to the relief line 27. In order to deflect the regulating valve 26 in the direction of its first or second end position starting from the illustrated starting position of the regulating valve 26, an actuator is provided on the regulating valve 26. In the exemplary embodiment illustrated, the actuator is designed as an electromagnet 28.

The electromagnet 28 is subjected via a control device 29 to a setting signal which is supplied to the electromagnet 28 via a first signal line 30.

During the operation of the hydrostatic-mechanical drive system 1, it may occur, for example, that a load which has been lifted by moving the setting piston 16 exerts a force on the setting piston 16 owing to its gravitational force. If the lifted load is lowered again, then the pressure medium displaced in the first setting pressure chamber 17 must normally be relieved to the tank volume 23 in a throttled manner via the regulating valve 26. In this case, heat is produced at the regulating valve 26 which cannot be utilised for the recovery of energy.

In order to be able to utilise, for example, such released energies, according to the invention the energy accumulator unit 31 is provided. The energy accumulator unit 31 has an accumulator element 32 for accumulating pressure energy. The accumulator element 32 is designed, for example, as a hydraulic diaphragm accumulator. The energy accumulator unit 31 furthermore has a hydrostatic machine 33. The hydrostatic machine 33 can be operated both as a pump and as a motor and is provided for delivering or for taking up pressure medium from two or in two directions. The delivery or absorbing volume of the hydrostatic machine 33 is adjustable. The hydrostatic machine 33 can be coupled to the mechanical part of the drive system 1 via a machine drive shaft 34. For this purpose, a mechanical interface 35 is formed at the end of the machine shaft 34 remote from the hydrostatic machine 33. In the exemplary embodiment illustrated, the machine drive shaft 34 is coupled to the gearing input shaft 7 at the mechanical interface 35. Thus, the hydrostatic machine 33 can also be mechanically driven by the diesel internal combustion engine 2 via the machine drive shaft 34. Conversely, a torque produced by the hydrostatic machine 33 can be supplied to the mechanical part of the drive system 1 via the machine drive shaft 34 and the mechanical interface 35.

The hydrostatic machine 33 is connected to the accumulator element 32 via an accumulator line 36. If, for example, mechanical energy is supplied to the hydrostatic machine 33 by the diesel internal combustion engine 2 or by the hydrostatic gearing 3 in overrun condition of a driven vehicle and therefore pressure medium is delivered by the hydrostatic machine 33, then pressure energy can be accumulated in the accumulator element 2, while increasing the pressure in the accumulator element 2. For this purpose, pressure medium is delivered to the accumulator element 32 via the accumulator line 36 by the hydrostatic machine 33.

The energy accumulator unit 31 furthermore has a hydraulic interface 38. The hydraulic interface 38 can be connected to the accumulator line 36 via an interface line 37. The end of the interface line 37 remote from the hydraulic interface 38 opens into the accumulator line 36 at a connecting point 39.

Arranged in the interface line 37 is a controllable valve 40, by which the interface line 37 can be interrupted. The controllable valve 40 is in this case adjustable continuously between its two end positions. In its first end position, which corresponds to the position illustrated in FIG. 1, the interface line 37 is completely interrupted. In the second end position of the controllable valve 40, in contrast, a practically unthrottled connection of the interface line 37 is established, so that the hydrostatic interface 38 is connected to the connecting point 39 in an unthrottled manner.

The hydrostatic machine 33 is adjustable with regard to its flow direction and its delivery or absorbing volume. An adjusting device 41, which cooperates with an adjusting mechanism of the hydrostatic machine 33, serves for this purpose. Both the controllable valve 40 and the adjusting device 41 are controlled by a control unit 42. The control unit 42 is preferably an electronic control unit.

In order to control the controllable valve 40, a control signal is emitted by the control unit 42 and supplied to an electromagnet 43. Instead of the electromagnet 43, other actuators may also be used for actuating the controllable valve 40. In particular, it is also possible, for example, for a control pressure which acts on a corresponding measuring surface of the controllable valve 40 to be produced by the control unit 42.

In the exemplary embodiment illustrated, when the controllable valve 40 is subjected to a force by the electromagnet 43, the controllable valve 40 is moved in the direction of its first end position, in which the connection between the hydrostatic interface 38 and the connecting point 39 is interrupted. In the opposite direction, the force of a setting spring 45 acts on the controllable valve 40. The force of the setting spring 45 thus urges the controllable valve 40 in the direction of its second end position, which the controllable valve 40 occupies as soon as force of the spring 45 exceeds the oppositely directed force of the electromagnet 43.

With the aid of the controllable valve 40, it is thus possible to control a volume flow in the interface line 37 and thus influence an energy flow via the hydraulic interface 38. The control unit 42 furthermore produces a control signal for the adjusting device 41. In dependence on the control signal of the control unit 42, the delivery or absorbing volume of the hydrostatic machine 33 is thus set. Through the setting of the delivery or absorbing volume of the hydrostatic machine 33, the energy flow via the mechanical interface 35 is thus controlled by the control unit 42. The control signal is supplied to the adjusting device 41 via a control line 44.

In order to be able to control the energy flows via the hydraulic interface 38 and via the mechanical interface 35 of the energy accumulator unit 31, so that optimised energy utilisation is obtained in the drive system 1, the control unit 42 cooperates with the control device 29. The control device 29 passes on information about the respective power requirement of the mechanical part of the drive system 1 and of the hydrostatic part 4 of the drive system 1 to the control unit 42 via a control line 46 and the corresponding control interface 46′ of the energy accumulator unit 31. The control device 29 is in this case provided for controlling the drive system 1 and, for this purpose, is connected to the electromagnet 28 of the regulating valve 26 via a further signal line 30. Therefore, the information is available in the control device 29, for example, as to whether potential energy is released at the working hydraulics 14 by lowering a load. In such a situation, for example, the electromagnet 43 of the controllable valve 40 is de-energised, so that pressure medium can be delivered via the hydraulic interface 38. For this purpose, the hydraulic interface 38 is connected to the first setting pressure line 20 via an interface line section 37′. The pressure medium displaced from the first setting pressure chamber 17 is thus delivered to the energy accumulator unit 31 via the first setting pressure line 20 and the interface line section 37′ and can be supplied to the accumulator element 32 for accumulating the released energy.

In the above-described situation, the adjusting device 41 is controlled in such a way that the hydrostatic machine 33 is set, for example, to a negligible delivery or absorbing volume. A pressure medium supplied via the hydrostatic interface 38 can therefore be delivered only into the accumulator element 32. If, subsequently, the load is lifted again by the working hydraulics 14, the pressure medium accumulated under pressure in the accumulator element 32 is delivered in the opposite direction to the first setting pressure chamber 17 again. The accumulated potential energy is thus available to the system again.

Furthermore, it is also possible to supply energy which can be accumulated in the form of pressure energy to the energy accumulator unit 31 by driving the hydrostatic machine 33 via the mechanical interface 35. The hydrostatic machine 33 then acts as a hydraulic pump. The hydrostatic machine 33 is adjusted to an appropriate delivery volume in order to accumulate, for example, excess mechanical energy which is supplied via the mechanical interface 35. The hydrostatic machine 33 consequently takes in pressure medium from a further tank volume 47 via the machine suction line 48 and delivers it to the accumulator line 36. The pressure medium which is under pressure passes via the accumulator line 36 into the accumulator element 32 and is available there for subsequent utilisation in the form of pressure energy. The subsequent utilisation may take place either via the hydrostatic machine 33 or may be supplied, via the hydraulic interface 38, directly to the hydrostatic part 4 of the drive system 1. Depending on the direction in which the energy flow of the accumulated energy is to take place, the adjusting device 41 or the electromagnet 43 is actuated via the control unit 42. When utilising the accumulated energy of the accumulator element 32 in the form of mechanical energy via the mechanical interface 35, the electromagnet 43 is energised and thus pressure medium is prevented from flowing off via the hydrostatic interface 38. The pressure medium which is accumulated under high pressure in the accumulator element 32 is consequently relieved to the further tank volume 47 via the hydrostatic machine 33. In this case, the hydrostatic machine 33 is operated as a hydraulic motor. The absorbing volume of the hydraulic motor is set here by the adjusting device 41 as a result of a control signal of the control unit 42.

In order to be able to decide whether an energy flow is appropriate in a particular direction, a first pressure sensor 53 and a second pressure sensor 54 are provided. The first pressure sensor 53 and the second pressure sensor 54 are arranged on both sides of the controllable valve 40 in the interface line 37. The pressure prevailing in the accumulator element 32 is thus measured by the first pressure sensor 53. The second pressure sensor 54, in contrast, measures the pressure prevailing in the hydrostatic part 4 of the drive system 1 and in the first setting pressure chamber 17 there.

The signals of the first pressure sensor 53 and of the second pressure sensor 54 are supplied to the control unit 42 via a first sensor line 55 and a second sensor line 56, respectively. It is thus possible to analyse via the control unit 42 whether a particular energy flow via the hydrostatic interface 38 or via the mechanical interface 35 is possible or not. If, for example, a situation has been detected by the control unit 29 in which potential energy is released by the working hydraulics 14, then by comparing the measured values of the first pressure sensor 53 and of the second pressure sensor 54 it is checked whether it is possible to fill up the accumulator element 32. If the accumulator element 32 is already completely full or if a positive pressure difference is present between the first pressure sensor 53 and the second pressure sensor 54, then it is not possible to fill up the accumulator element 32. The electromagnet 43 is in this case energised and the load is lowered conventionally via the regulating valve 26. In a corresponding manner, by evaluating the signal of the first pressure sensor 53 it is possible to detect whether the pressure prevailing in the accumulator element 32 can be utilised to produce a torque on the machine drive shaft 34. If the pressure in the accumulator element 32 has dropped below a particular threshold value, then it is not possible to remove pressure medium in order to produce torque by the hydrostatic machine 33. In this case, the hydrostatic machine 33 remains set at its neutral position. The signals of the two pressure sensors 53 and 54 are also used to check whether additional accumulation of energy is possible in the accumulator element 32 by operating the hydrostatic machine 33 as a pump and whether it is possible to remove energy from the accumulator element 32 by an energy flow via the hydrostatic interface 38.

In order to enable a direct conversion of energy, for example, through released potential energy on the part of the working hydraulics 14 and a conversion to mechanical energy via the mechanical interface 35, a shut-off valve 49 is provided. The shut-off valve 49 is arranged in the accumulator line 36 between the accumulator element 32 and the connecting point 39. If the shut-off valve 49 is in its closed position, then it is possible, for example when the controllable valve 40 is connected through and the hydrostatic unit 33 is pivoted out, to immediately supply released potential energy to the energy accumulator unit 31 via the working hydraulics 14 and the hydraulic interface 38. This pressure is relieved via the hydrostatic machine 33 and converted there to a torque which is output via the mechanical interface 35. The energy accumulator unit 31 thus converts hydraulic energy to mechanical energy by the control unit 42 appropriately controlling the controllable valve 40 and the hydrostatic machine 33, and supplies it to the mechanical part of the drive system 1. An energy flow is thus produced via the hydrostatic interface 38 into the energy accumulator unit 31 and via the mechanical interface 35 out of the energy accumulator unit 31.

In a corresponding manner, it is possible to produce an energy flow in the opposite direction. For this purpose, the hydrostatic machine 33 is either driven via the hydrostatic gearing 3 in overrun condition of a vehicle or via the diesel internal combustion engine 2 and the gearing stage 6. In this case, the hydrostatic machine 33 acts as a mechanically driven pump which delivers pressure medium to the accumulator line 36. If the shut-off valve 49 is in its closed position, then the pressure medium is delivered into the accumulator line 36 by the hydrostatic machine 33 and is supplied to the hydrostatic part 4 of the drive system 1 via the interface line 37 and the hydraulic interface 38.

In the exemplary embodiment illustrated, the shut-off valve 49 is moved into its closed position by the force of a compression spring 50 when the electromagnet 51 is de-energised. The hydrostatic machine 33 can thus be used as an additional hydraulic pump for accelerated lifting of loads by the working hydraulics 14. The hydrostatic machine 33 is in this case driven by the diesel internal combustion engine 2, just like the pump 22. The hydrostatic machine 33 and the pump 22 thus deliver pressure medium in parallel into the first setting pressure chamber 17. In order to fill and remove pressure medium, the shut-off valve 49 is moved into its open position by actuating the electromagnet 51.

The use of a hydrostatic gearing 3 as a mechanical part of the drive system 1 and of working hydraulics with a lifting cylinder 15 as the hydrostatic part 4 of the drive system 2 was selected merely to describe the functioning of the of the energy accumulator unit 31 by way of example. The energy accumulator unit 31 can, however, be combined in any way with drive systems which have a mechanical part and a hydrostatic part 4. In order to connect the energy accumulator unit 31 to such a drive system 1, the mechanical interface 35 and the hydrostatic interface 38 are formed. The energy flow via the interfaces 38, 35 is controlled by the control unit 42, so that the energy accumulator unit 31 acts on the one hand as an energy converter and on the other hand as an energy accumulator including the accumulator element 32.

If pure energy conversion, that is to say the production of an identical energy flow simultaneously via the two interfaces 35, 38 without surrounding the accumulator element 32 is not required, then in an alternative embodiment the shut-off valve 49 can also be dispensed with. Likewise, it is possible to take up mechanical and hydraulic power simultaneously via the two interfaces 35, 38 or to release accumulated energy simultaneously via both interfaces 35, 38.

With the proposed energy accumulator unit 1, it is possible on the one hand in a simple matter to expand existing systems with highly flexible energy accumulation and an energy management system. Moreover, energy peaks which occur can be easily absorbed. One possible application is, for example, vibration damping of a working cylinder. The pressure peaks which occur during vibration can be accumulated in the form of pressure energy in the accumulator element 32. A preferred area of use of the energy accumulator unit 31 is in mobile working machines with a hydrostatic travel drive and working hydraulics.

The invention is not limited to the exemplary embodiment illustrated. Rather, the combinations of individual features with one another are possible.

1. Energy accumulator unit for a hydrostatic-mechanical drive system, the energy accumulator unit having at least one hydrostatic machine, which can be connected to a drive system via a mechanical interface, an accumulator element, which is connected to the hydrostatic machine via an accumulator line, and a hydraulic interface, which can be connected to the accumulator line and serves to connect the energy accumulator unit to the drive system.

2. Energy accumulator unit according to claim 1,
wherein the energy accumulator unit comprises a control unit for controlling an energy flow via the mechanical interface and/or the hydraulic interface, it being possible for the control unit to be connected to the drive system via a control interface.

3. Energy accumulator unit according to claim 1,
wherein the hydraulic interface can be connected to the accumulator line via an interface line and a controllable valve is arranged in the interface line.

4. Energy accumulator unit according to claim 3,
wherein the controllable valve can be controlled by the control unit.

5. Energy accumulator unit according to claim 3,
wherein a pressure sensor is arranged in the energy accumulator unit on both sides of the controllable valve.

6. Energy accumulator unit according to,
claim 1, wherein the hydrostatic machine is provided for two flow directions and is adjustable in its delivery or absorbing volume.

7. Energy accumulator unit according to claim 6,
wherein the hydrostatic machine can be controlled by the control unit in order to set its flow direction and its delivery or absorbing volume.

8. Energy accumulator unit according to,
claim 1, wherein a shut-off valve is arranged between a connecting point of the accumulator line, to the interface line, and the accumulator element.
